(19) United States
(12) Patent Application Publication
(10) Pub. No.: US 2012/0022932 A1
(43) Pub. Date: Jan. 26, 2012

(54) DIGITAL DATA PROCESSING SYSTEMS AND METHODS FOR ELECTRONIC COMMERCE

(75) Inventors: Jason J. Ossenmacher, Mission Viejo, CA (US); Lawrence S. Rogel, Brookline, MA (US); Colin L. Hom, Menands, NY (US)

(73) Assignee: IntelliSysGroup, LLC, Cambridge, MA (US)

(21) Appl. No.: 12/841,779

(22) Filed: Jul. 22, 2010

(51) Int. Cl. G06Q 30/00; G06Q 90/00

(52) U.S. Cl. 705/14.23; 705/500; 705/26.8

(57) ABSTRACT

Disclosed herein are methods and apparatus for electronic commerce. By way of example, in one embodiment such methods and apparatus enable a buyer's digital data processor to make requests to an on-line store to view purchase options for a selected product/service as well as to view benefits for consummating those transactions. Further, a store's electronic display/register or a handheld computing device may enable a shopper in a physical store to view such information and earn benefits. Those benefits may differ by item and seller and may include money and/or points. With such money and/or points having been accumulated through on-line and brick and mortar store purchases, e.g. in buyer's account, a buyer's digital data processor can facilitate redemption of the money and/or points at the same or other stores, for example to purchase additional items or for other purposes.

### FIELD OF THE INVENTION

This patent application generally relates to methods and apparatus for electronic commerce, including, in particular, methods and apparatus for commerce involving the accumulation and redemption of money and/or points in connection with the sales of goods/services.

### BACKGROUND OF THE INVENTION

Markets allow buyers and sellers to exchange goods/services at agreed-upon prices. The function of markets, and in particular the effect of buyer and seller knowledge on market behavior, has been the subject of study over the years. For example, economists say that transparent markets, in which current pricing information is readily available, often function more efficiently. Markets generally function better, in other words, when buyers are apprised of pricing information with respect to multiple—and ideally, all—sellers across a market. The costs of obtaining such information may not be trivial, however. Whether because of those costs or other reasons, the knowledge of most buyers (and that of sellers) is often imperfect.

On another note, marketplace sellers often seek to encourage or incentivize buyers to consider their goods/services. Typically such efforts have included loyalty and rewards programs, affiliate programs, as well as advertising. Examples include well-known airline mile programs and credit card reward programs, among others. However, these efforts leave room for improvement, as is evidenced by the constant tinkering, and indeed periodic revamping, of such programs.

Accordingly, an object of the present invention is to facilitate the sale of goods/services, whether conducted in virtual stores, brick-and-mortar stores, or otherwise.

A further object of the invention is to provide buyers with improved information regarding potential purchase transactions and improved incentives for consummating those transactions, wherever those potential purchase transactions are contemplated and/or consummated.

Yet a further object of the invention is to enable sellers to reward loyal customers.

### SUMMARY OF THE INVENTION

The foregoing are among the objects attained by the invention, aspects of which provide improved methods and apparatus for conducting commerce, and particularly for consummating sales transactions in both on-line (also referred to herein as virtual stores) and in brick-and-mortar stores (also referred to herein as physical stores). Such methods and apparatus can involve, among other things, the accumulation and redemption of money and/or points by a buyer, e.g., in an account from which they can later be redeemed. It should be understood that the term “money” is used herein to refer to government-issued currency and equivalents thereof, whether in the form of cash, digital money (e.g., bank accounts, electronic funds and other money exchanged electronically) or otherwise. Points as used herein refers to units of counting, credit, value or exchange. Points are distinct from money, although they may be exchanged for money, products, and/or services in accord with the teachings hereof. Points, for example, may expire, may be assigned an exchange rate relative to money, and/or may be subject to other rules that differ from laws governing the accumulation and exchange of money.

In many cases, the apparatus employed in the novel methods disclosed herein include digital data processors coupled for communication with one another, e.g., via a communications network. Those digital data processors may be associated with (and, indeed, used by) buyers, sellers, and third parties. In the context of an on-line transaction, for example, such apparatus may include client digital data apparatus that is associated with a buyer and that is configured to exchange messages with a server digital data processing apparatus associated with a seller and serving web pages in response to requests from the client digital data processor. In the context of a ‘real-world’ transaction, such as a visit to a brick-and-mortar store, such apparatus may include a buyer's portable computer, personal digital assistant/cell phone and/or the store's computers, bar code scanners, registers, and so on.

In one aspect, an improved method of commerce involves the accumulation of money and/or points through purchase of goods and/or services in an on-line environment, in many cases through a merchant's virtual store, such as a web site with a plurality of web pages defining the store and enabling a virtual retail or wholesale shopping environment, or as defined by other applications, e.g., portal applications or proprietary software. A buyer digital data processor requests and receives information from a seller's digital data processor. In some cases, that information includes web page information, e.g., HTML and other web page elements, received from a seller's digital data processor configured as a web server. The web page elements describe and/or reference products/services offered by that store. In other cases, that information includes HTML or non-HTML data interpreted by a portal application running on the buyer's digital data processor, or other application user interface, which may emulate a browser experience.

The buyer digital data processor responds to input received from the buyer indicating the selection of a certain item for potential purchase and transmits information about the product/service that has been selected and/or information about the seller to a digital data processor associated with the third party. The information so transmitted may include a code identifying the selected product/service/seller that the buyer digital data processor has determined from HTML defining one or more aspects of the virtual store, from a web address to which a browser program on the buyer digital data processor has been pointed by the buyer, from an applications program interface associated with the virtual store, from information the buyer inputs into the digital data processor in connection with the potential purchase transaction, or otherwise, as will be described in more detail below. Alternatively, the buyer digital data processor may transmit such HTML, web address, or other data to the third party digital data processor so that the third party digital data processor can itself extract identifying information about the product/service/seller.

Continuing with the example, the third party digital data processor communicates back to the buyer digital data processor information for display to the buyer. That information indicates that the buyer will earn a benefit for consummating the purchase of the selected goods/services, for example in the form of money and/or points credited to the buyer's account. That buyer's account, which can be maintained by the third party digital data processor, the seller digital data processor, or another device/entity, serves as repository for information regarding money and/or points accumulated in various purchases the buyer makes. In some cases, the buyer may designate another account, for example that of a charitable organization or other beneficiary, to receive the money and/or points in lieu of the buyer.

In many cases, the third party digital data processor returns information about such potential benefits in real-time. It often takes place substantially simultaneously with the communication of information about the buyer's selected product/service/seller, and with the buyer's selection itself. It also can take place substantially simultaneously with the initiation of a “check out” routine on the buyer digital data processor, which can indicates that a buyer is about to “check out” of the virtual store. In other cases, the third party digital data processor returns the information within the same online session or browser session, or within a minute or two after receiving the information from the buyer digital data processor.

The third party digital data processor also communicates to the buyer digital data processor, for example, data for display to the user about options or alternatives to the potential purchase transaction that the buyer initially selected. Such alternatives may include similar products offered by the same seller, or the same or similar products offered by alternate sellers, with each such alternative being associated with a specified benefit.

Based on input received from the buyer about the desired transaction, the buyer digital data processor consummates the purchase transaction with the digital data processor associated with the original seller or an alternate seller. As part of the consummation, information about payment, shipping and other information may flow between those digital data processors. In view of this consummated transaction, the seller digital data processor transfers directly or indirectly, e.g., through banking network/system, to the third party digital data processor an amount of money, and/or a notification/receipt of the transfer of an amount of money thereto. The amount of money transferred from the seller to the third party can be based on one or more characteristics of the consummated transaction, e.g., on the total sale, the nature of an affiliation between the seller and the third party, according to the predetermined terms or formulae, or otherwise.

The consummation of the transaction can also trigger the third party digital data processor to credit the account of the buyer or a designated beneficiary (e.g., a charity) with an amount of money and/or points, and to send the buyer digital data processor a message confirming or notifying it about such crediting. The amount to be credited to the buyer can be fixed, or based on an agreed-upon arrangement or formula. For example, the amount can be based on the amount of the consummated purchase transaction or the amount of money trans-ferred to the third party from the seller, and, in the case of points, in accordance with an “exchange rate” between money and points.

In some aspects of the invention, the process of communicating information about the potential purchase transaction to the third party digital processor and the third party digital data processor communicating one or more benefits flowing from consummation of such transactions (either with the original seller, an alternate, or otherwise) can be repeated multiple times for multiple respective purchase transactions with one or more sellers and/or one or more products services. Those sellers may be different sellers, the products/services having been collected from different virtual stores into a universal shopping cart. The third party digital data processor can communicate to the buyer digital data processor, for consolidated display to the buyer for example, amounts of money and/or points to be earned for each of the multiple purchase transactions upon consummation thereof. Any or all of such consolidated purchase transactions can be selected/consummated by the buyer from that display.

In other aspects of the invention, purchase transactions earning a buyer money and/or points, such as those described above, can take place in a brick-and-mortar store, following at least some if not most of the steps of the process described above. In the brick and mortar store, the product/service code and/or the store code can be determined from a bar code on the product and communicated to a third party digital data processor via a network. In some cases, the buyer may input the product information using their own portable computer or personal digital assistant/cell phone that they have brought to the store and pointed to a web page provided by the third party digital data processor for that purpose. Further, the seller identification code can be determined from the location of the brick-and-mortar store or through input from the purchaser, for example, via the aforementioned buyer's digital data processor, or one that is provided by the store. Information about the purchase options and/or the benefit to be earned can be returned by that digital data processor for display to the buyer, for example, via in-store display terminal, via a user's own portable digital data processing device, such as a laptop, personal digital assistant/cell phone.

Other aspects of the invention include methods of redeeming money and/or points earned by the buyer, such as those accumulated with the above-recited purchase transactions. The redemption transaction can take place in the context of a virtual store or a brick-and-mortar store, regardless of where or how the money and/or points were originally earned.

For example, in one exemplary method a buyer digital data processor, acting at the direction of a buyer for example, makes requests for web page elements of a virtual store. The buyer digital data processor responds to input received from the buyer that indicates the selection of a certain item for potential purchase, and communicates information about that selection, e.g., identifying the product/service/seller with a code, as set forth above. The third party digital data processor receives and responds to the buyer digital data processor with information about the amount of money and/or points accrued in an account associated with the buyer. The buyer digital data processor may display that information to the buyer. Such a display can inform the buyer as to an accumulated balance, for example, or a redemption price or cost (in terms of accumulated money and/or points) to purchase the selected product/service or to subsidize part of the purchase price. As previously mentioned, the redemption price can be based on the price of the product/service, e.g., using an exchange rate between money and points, on the nature of an affiliation between the seller and the third party, or on other criteria. In some embodiments, the redemption options include alternative products/services and/or sellers, each of which may be associated with different redemption costs.

The buyer digital data processor then receives input from a buyer about which redemption option is to be taken, and exchanges messages with the selected seller's digital data processor to consummate the transaction on that basis. The third party digital data processor debits the buyer's account for the designated amount of money and/or points.

In the foregoing example, the buyer has redeemed money and/or points in their account rather than paying the seller, so the third party digital data processor transfers money (and/or send a notification that money is to be transferred or has been transferred) to pay for the goods/service to the seller. In many cases, however, the amount to be transferred can reflect a credit to the third party for a referral fee, e.g., in accordance with established terms between the seller and third party.

As previously mentioned, the redemption process can also be implemented in a brick-and-mortar store, e.g., along the lines described above. For example, a digital data processor located in the seller's store (e.g., a register, a computer console/terminal available to shoppers) may be used by the buyer and fulfill the role of the buyer digital data processor as previously described. Furthermore, other peripherals such as a bar code scanner or optical scanner can be used to input the product/service code of a selected item for transmission to the third party digital data processor. In further embodiments, a laptop, personal digital assistant/cell phone, and so on, can be used by the buyer and fulfill the role of the buyer digital data processor as described above.

In yet other aspects of the invention, an exemplary method of commerce involves communicating, in connection with a potential purchase transaction between a buyer and a seller, any of a product/service being purchased and a seller identification to a shopping cart function. In some cases, the shopping cart functionality can be provided by the third party's digital data processing apparatus, and in other cases can be provided by the seller's apparatus, or by an application running on the buyer's own digital processor, or otherwise.

The communication of the product/service being purchased and/or a seller identification to the shopping cart function can be performed for multiple respective purchase transactions with multiple respective sellers to generate multiple potential purchase transactions, and by doing so can track multiple potential transactions across, for example, many different virtual stores which the buyer has visited, collecting items into a universal shopping cart defined by the shopping cart functionality. The multiple potential purchase transactions can be communicated to the buyer digital data processor for consolidated display, based on which the user chooses one or more of those transactions to consummate.

The method can also include communicating to the buyer digital data processor, for display to the buyer, a benefit inuring from the third party as a result of consummating one or more of the potential purchase transactions. For example, the consolidated display can also include an indication of amounts of money and/or points that will be credited to the buyer's account, or to another account of the buyer's choosing, upon consummating one or more of the multiple potential purchase transactions. The amount of money and/or points credited can be based on the amount of the consummated purchase transaction, or based on other criteria. In some cases, the amount of money and/or points credited to the buyer can be based on an amount of money transferred by the seller to the third party as a result of the one or more consummated purchase transactions, which itself may be based on the amount of the one or more consummated purchase transactions and/or on the nature of an affiliation or relationship between the third party and seller.

Still further aspects of the invention provide combinations of the systems, apparatus and methods described above.

These and other aspects of methods and apparatus according to the invention are evident in the drawings and in the description below.

### BRIEF DESCRIPTION OF THE DRAWINGS

A more complete understanding of the invention may be attained by reference to the drawings, in which:

FIG. 1 depicts exemplary digital data processing apparatus connected via networks for effecting methods of commerce as disclosed herein;

FIG. 2 depicts exemplary methods of completing an on-line purchase and accumulating money and/or points in accordance with one aspect of the invention;

FIG. 3 depicts exemplary methods of completing a brick-and-mortar store purchase and accumulating money and/or points, in accordance with one aspect of the invention;

FIG. 4 depicts exemplary methods of redeeming accumulated money and/or points in an on-line purchase, in accordance with one aspect of the invention; and,

FIG. 5 depicts exemplary methods of redeeming accumulated money and/or points in a brick-and-mortar store purchase, in accordance with one aspect of the invention.

### DETAILED DESCRIPTION OF THE ILLUSTRATED EMBODIMENT

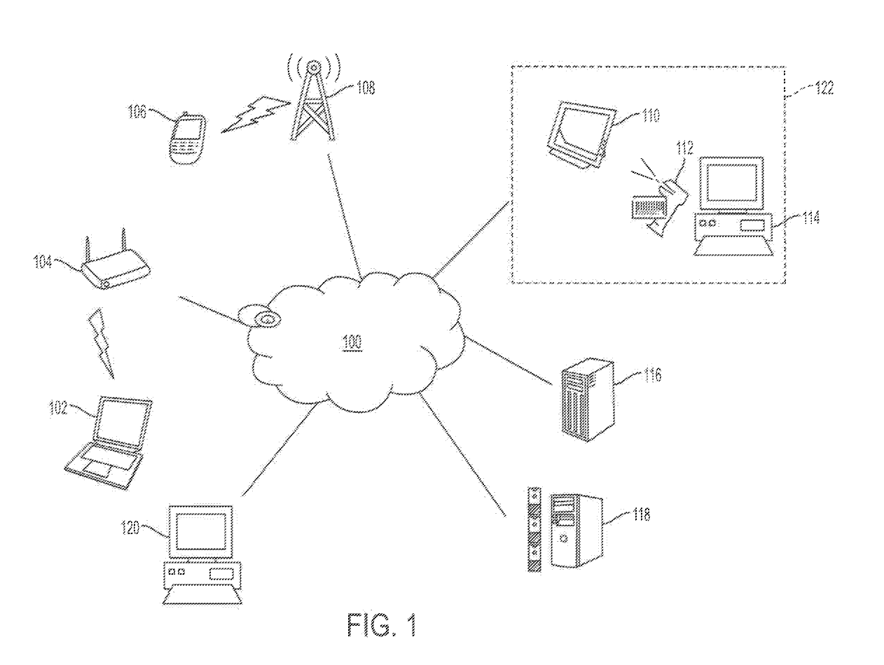

FIGS. 1-5 depict exemplary methods and apparatus of conducting commerce in both on-line and brick-and-mortar store environments. It should be understood, at the outset, that the methodologies depicted in the Figures and described herein may be implemented in a variety of ways. FIG. 1, by way of example, depicts a plurality of digital data processors 102-120 of the type commercially available in the marketplace, modified in accord with the teachings herein to effect novel methods of electronic commerce.

Although alternate configurations fall within the scope of the invention, FIG. 1 depicts a personal computer 120, laptop computer 122 and personal digital assistant/cellular phone 106 which may be used by a buyer to shop online from a residence, workplace, during visits to physical store (here represented by box 122), or other location. The various digital data processing devices 102-120 are coupled for communication with one another via one or more communication networks arranged in known manners and utilizing known protocols (IP, TCP, Ethernet, and so on) to effect remote communication therebetween, all as adapted in accord with the teachings hereof. In FIG. 1, such networks are represented collectively by network cloud 100, with wireless router 104 providing wireless network access to laptop 102 and radio tower 108 providing cellular/data service to personal digital assistant/cell phone 106. Accordingly, network 100 may be constituted of local area and wide area networks, WIFI, virtual private networks, and the Internet, or otherwise.

In FIG. 1, the digital data processing devices associated with the buyer and with the physical store 122 can access, via such networks, a server digital data processor 116 maintained by an on-line seller and providing a virtual store. In this example, the store 122 includes a computerized register 114, tablet computer/display console 110, and a bar code scanner 112. Also shown is a digital data processor 118 associated with a third party, e.g., to provide purchase options and maintain money and/or points in accounts, as further described herein.

Digital data processing devices 102-120 may be coupled to input devices such as a mouse, keyboard, keypad, touchscreen, touchpad, optical or bar code scanner, magnetic reader, optical sensor, camera, and the like, and to output device such as electronic displays, audio speakers, and the like. The internals of such digital data processors may include processors, memory, interface (I/O) devices, network devices, communication controllers (e.g., bluetooth, universal serial bus), wireless signal transmitters and receivers, or other circuitry.

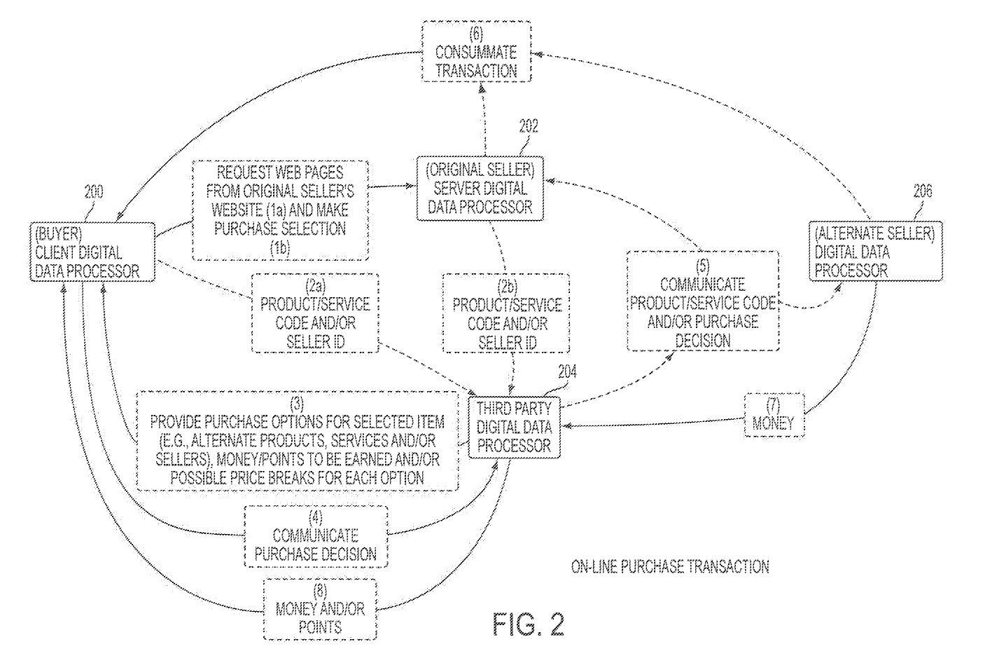

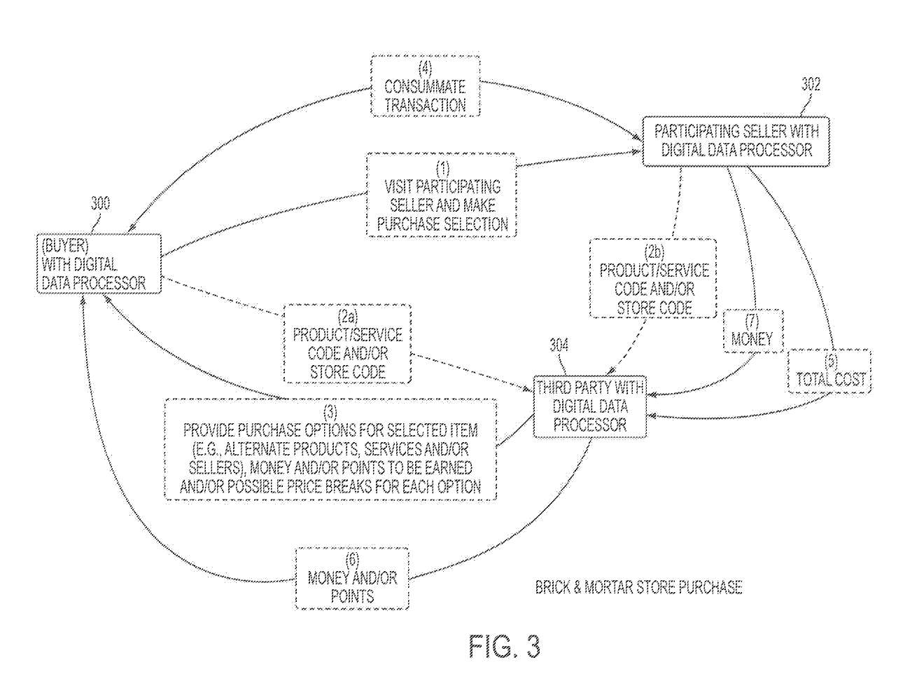

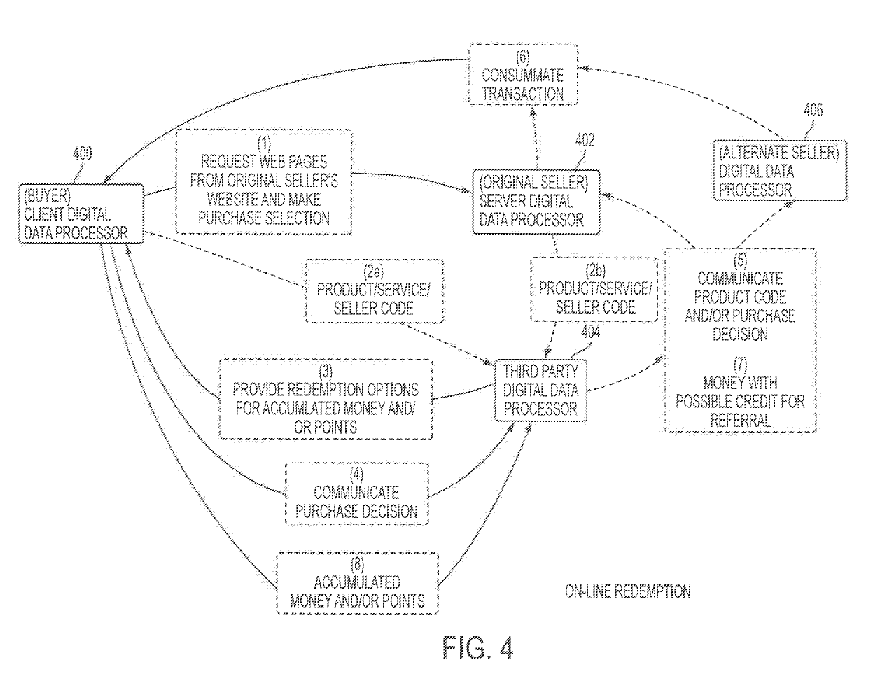

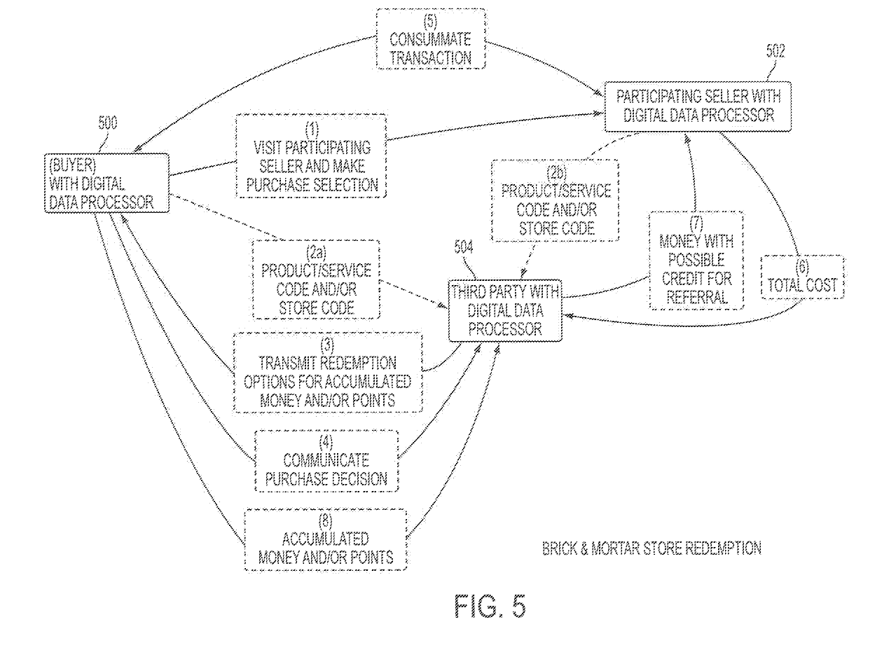

In view of the foregoing, it should be understood that references herein to communication between “the buyer and the seller”, “the third party and the alternate seller”, and the like, are intended to contemplate and include communications between digital data processors associated with those buyers, third parties, and sellers. FIGS. 2 and 4 represent on-line transactions and contain diagrams with elements labeled “buyer digital data processors,” “seller digital data processors” and the like. FIGS. 3 and 5 represent transactions in physical stores, in which a variety of digital data processing apparatus associated with both buyers and sellers may be employed in various roles (e.g., a buyer may use a seller's digital data processor to inquire about a purchase transaction, or in other embodiments may use one digital data processor to inquire but another, or none at all, to consummate a transaction). Accordingly, for convenience and clarity, FIGS. 3 and 5 are diagrammed to show “buyers” and “sellers,” and “third parties” that are “with digital data processors”. However, as will be apparent from the description below, a wide variety of digital data processors can be used to effect the steps attributed to buyers, sellers, and third parties in FIGS. 3 and 5 and, in sum, the processes depicted in FIGS. 3 and 5 can involve communications between a wide variety of digital data processing devices, e.g., to effect steps attributed to the buyers, sellers and third parties.

An on-line purchase transaction is diagrammed in FIG. 2. Buyer digital data processor 200 represents a digital data processor (such as a personal computer) used by a buyer for on-line shopping. Buyer digital data processor 200 executes client software (e.g., a browser or a dedicated portal application) to request and receive web page elements other user interface elements (collectively referred to hereinafter as display or user-interface elements) provided by a seller's server digital data processor 202 (here referred to as an “original seller” digital data processor since other sellers may become involved), which configured as a server. In the case of a browser-based user interfaces, those elements include markup language code, such as hypertext markup language (HTML), and images, videos, graphics, multimedia functionality, applets, common gateway interface functionality, or any of a variety of elements and modules known in the art of web design and construction. The organization and representation of such elements may be in accord with accepted standards such as the document object model (DOM) publicized by the W3C organization (w3.org). The UI elements collectively may represent a virtual store of interest to the buyer. (Step 1a.)

The buyer digital data processor 200 operates under the control of the buyer to navigate to selected web pages and/or issues requests for information about selected products/services from the server digital data processor 202, at the buyer's behest. (Step 1b.) The buyer digital data processor may also request that selected products/services be added to a virtual “shopping cart,” using functionality offered by the seller digital data processor 202, or initiate a purchase transaction for that product/service.

The buyer digital data processor 200 and/or the seller digital data processor 202 transmits a seller identification code and/or a code identifying the selected product/service to a third party digital data processor 300. (Steps 2a and 2b.) The inclusion of both Steps 2a and 2b with dotted lines in FIG. 1 reflects the possibility that either or both of those steps may occur. In other words, the identifying codes may be transmitted to the third party digital data processor from the buyer digital data processor 200 and/or the original seller digital data processor 202. For example, to report such information a code reporting program executing on the client digital data processor 200 may be invoked at the time of product/service selection by the buyer, triggered by the buyer clicking a “purchase” or “checkout” button in the virtual store or by pre-arranged keystroke once the selected product/service page has been loaded.

The code reporting program can determine a seller/product/service code or other information pertaining to the transaction. In some implementations, this determination can be made based on information supplied to the code reporting program by the browser about the web site or application server the buyer is visiting. (FIG. 2a.) The code reporting program may inspect the DOM of the page to glean and interpret information therefrom. In another embodiment, it may inspect the HTTP address of the page at which the browser is pointed, which typically includes a code representing the product being displayed and/or purchased in the body of the page, as well as identifying the site and, hence, the seller. In other embodiments, it may query the operating system to identify user interface (UI) elements, such as text, input boxes, etc., over which the buyers cursor is disposed. The code reporting program may use the application programming interface associated with the virtual store to interpret the information contained in the web page and thereby determine a code. And in yet another embodiment, an optical character recognition routine may be executed on all or a portion of the page under display, so as to capture and identify text relevant to the product. Regardless of the technique employed, once the desired information is obtained the code reporting program can cause it to be transmitted to the third party digital data processor 204. (Step 2a.)

As indicated by step 2b, the seller's server digital data processor 202 can also report the seller/product/service code, or other information, to the third party digital data processor 204. For example, participating sellers may build functionality into their virtual store allowing a visitor to select a product/service for purchase and then transmit information about that potential purchase to the third party as a prelude to initiating a purchase transaction. In such cases, the buyer digital data processor 200 may receive identifying information from the buyer so that the seller digital data processor and/or third party digital data processor can verify the buyer's account with the third party and provide appropriate/customized information to the buyer.

Continuing the example illustrated in FIG. 2, the third party digital data processor 204 uses the product/service/seller code to create and communicate data representing a menu of purchase options to the buyer digital data processor 200 for display to the buyer. (Step 3.) At a first level, the purchase options may inform the buyer that purchasing the selected product/service will result in a benefit, such as a credit of a specified amount of money and/or points to the buyer's account, or an account of the buyer's choosing, that is maintained with the third party.

In addition to specifying benefits, purchase options may also include similar products from the original seller and the same or similar products from alternate sellers. Each of these options may carry a different cash price, and may earn different amounts of money and/or points. As a result, the buyer digital data processor can present to the buyer a range of purchasing options related to the product/service which initially interested them.

Information regarding purchase options can be transferred directly between the third party digital data processor 204 and the buyer digital data processor 200, e.g., via a purchase options reporting/display module executing on the buyer digital data processor 200 configured to receive and display that information. That information can also be transferred to the original seller digital data processor 202, which can in turn provide them to the buyer's digital data processor 200 for display to the buyer.

In Step 4, the buyer digital data processor 200 receives user input from the buyer indicating the buyer's decision about the purchase options and communicates that decision regarding the purchase to the third party digital data processor 204 (either directly or through the original seller digital data processor 200). The third party digital data processor 204 communicates information about the desired item, for instance a code or other identification of it, to the appropriate seller, be it the original seller or an alternate seller, along with the buyer's decision to purchase that product. (Step 5.) The purchase transaction is consummated between the buyer digital data processor 200 and the appropriate seller digital data processor. (Step 6.) The consummation of the purchase transaction can involve the confirmation of the buyer's identity and decision, application of taxes, the communication of payment and shipping information, issuance of a receipt, and so on, as commonly occurs with the purchase and sale of goods/services.

In Step 7, the consummation of the selected purchase transaction triggers the seller digital data processor to transfer money, and/or a notification/receipt that money is to be transferred, to the third party digital data processor 204. In some cases the seller digital data processor sends a notification/receipt that the money will be transferred by some other system, such as banking network and associated computers, e.g., via electronic funds transfer or otherwise. FIG. 1 depicts the “alternate seller” as the chosen seller, so the diagram depicts the money being transferred from box 206 to 204. However, if the buyer had selected the original seller, the transfer of money would flow from 202 to 204; that arrow has been omitted to avoid cluttering the diagram.

The amount of money transferred from seller to the third party may be a fixed amount or based on the amount of the total purchase transaction, on the kind or type of products/services purchased, the nature of a relationship or agreement between the seller and the third party, or in almost any other way. In some cases, the transferred money may be treated or represent a “referral fee.”

In Step 8, the third party 204 credits the buyer's account (or another account designated by the buyer) with the appropriate amount of money and/or points, notifying the buyer of the same. The amount of money and/or points credited may be based on the same or other factors as provided above. In some implementations, furthermore, an “exchange rate” may be established to convert between the total sale of the purchase transaction and the amount of points to be credited.

FIG. 3 illustrates a purchase transaction at a brick-and-mortar store. The buyer 300 visits the seller's store, perhaps because the store advertises its participation in the third party's program. (Step 1.) The buyer 300 selects an item in the store for potential purchase, and causes information about the product/service/seller associated with that item to be transmitted to the third party digital data processor 304 or to other apparatus for communication to the third party. This information transfer to the third party digital data processor 304 can be accomplished in several ways. For example, accessing a web page or application page served by the third party server, the buyer may input product/service/seller codes, and/or may input a description of the item, using a portable computer or personal digital assistant/cell phone while shopping at the store. A store clerk may be able to enter such information using the seller's store consoles, either directly or by scanning the item with a bar code reader.

Based on the information received, the third party digital data processor 304 returns a set of purchase options to be displayed to the buyer. (Step 3.) As in the on-line context, the purchase options can include a benefit (e.g., of money and/or points credited to an account) for purchasing the selected item, as well as similar items offered by the seller which may earn other benefits. In some cases, for the brick and mortar store purchase, the communication and display of potential money/points to be earned from the prospective transaction may be sufficient. In other cases, however, the purchase options may also include the same or similar products from alternate sellers, although they may be less useful to the buyer, or even prohibited by agreement between the third party and seller, in the context of a purchase transaction in a physical store.

In step 4, the digital data processor in use by the buyer 300 (e.g., the portable computer, cell phone, store console, or otherwise) makes a decision about the purchase and consummates the transaction with the seller 302. Typically the consummation of the transaction with the seller 302 results in the input of information into the seller's digital data processing system (e.g., by inputting/scanning items into a computerized cash register, store computer, etc.). The seller's digital data processing system can inform the third party digital data processor 304 of the total cost of the confirmed purchase transaction. So informed, the third party digital data processor 304 credits the buyer 300 and/or sends a notification that such credit will take place, with an amount of money and/or points corresponding to the purchase option selected. (Steps 5 and 6.)

In Step 7, the seller digital data processor 302 transfers an amount of money to the third party based on the purchase transaction or characteristics thereof, and/or sends a notification/receipt to that effect. The characteristics of the purchase transaction can include, for example, the amount of the sale, the kind of product/service that was sold, the kind of buyer to whom the products/services were sold, the nature of the relationship or an agreement between the seller and the third party, and so on.

As a result of the transactions illustrated in FIGS. 2 and 3 and other like them, a buyer's account accumulates money and/or points from purchases both on-line and in physical stores. Methods and apparatus according to the invention also provide for redeeming that accumulated money and/or points. For example, the money can be remitted to the buyer on a periodic or other basis, while points can be converted to money and likewise remitted to the buyer. An exchange rate established by the third party can be used to control the cash redemption value of points. Different exchange rates can be established for different accounts: for example, a buyer's account may be subject to a different, potentially less favorable, exchange rate than that of a charitable organization, to whom the buyer may donate points.

Money and/or points accumulated in the buyer's account can be used to purchase products/services from sellers, or to pay for at least part of the cost of purchasing those products/services. The redemption of accumulated money and/or point for products/services is the subject of the examples depicted in FIGS. 4 and 5.

FIG. 4 illustrates an exemplary on-line redemption process, in which a buyer digital data processor executes a browser for accessing the seller's website, and, at the direction of a buyer, selects a product for purchase. (Step 1.) The buyer digital data processor 400 and/or the seller digital data processor 402 transmits information about the product/service/seller is transmitted to the third party digital data processor 404. (Steps 2a and 2b.) In step 3, the third party digital data processor 404 transmits for display to the user a set of redemption options, rather than the purchase options presented for the previously described purchase transactions. Those redemption options can include the option to redeem an amount of money and/or points in order to purchase the selected item, or at least to reduce the price necessary to purchase it. As with a purchase, the buyer digital data processor 400 may present to the user the option to select other items, from the original seller or an alternate seller, which are assigned different redemption prices.

In step 4, the buyer digital data processor 400 communicates the redemption decision to the third party digital data processor 404, which then informs the appropriate seller digital data processor. (Step 5.) The buyer digital data processor 400 consummates the transaction with the selected seller digital data processor 402, 406 (step 6), although the buyer digital data processor may not need to provide payment to the seller because of the redemption, or may need to pay only a discounted amount, the difference being made up by the redemption of buyer's accumulated money and/or points. In step 7, the third party digital data processor 404 transfers to the selected seller digital data processor (402, 406) an amount of money which compensates that seller for the buyer's purchase of the item, and/or a notification/receipt about the transfer of such amount of money. The amount of money that is transferred to the seller may be reduced by a credit for third party's referral, or pursuant to a previously agreed-upon arrangement between the third party and seller.

In step 8, the third party digital data processor 404 deducts the appropriate amount of money and/or points from the buyer's account to complete the redemption process.

FIG. 5 illustrates an exemplary redemption process that takes place in a brick and mortar store. In step 1, the buyer 500 visits the store of a participating seller 502 and selects an item for purchase. Through the buyer's portable computing device, the store's register, bar code scanner, or other device, information about the product/service/store (e.g., an identifying code) about the selected item is transmitted to the third party digital data processor 504. Based on that information, the third party digital data processor 504 returns data presenting redemption options to the digital data processor that send the information for display to the buyer 500, as described previously in connection with FIG. 3. The buyer 500 makes a decision regarding the redemption and consummates the purchase of the item with the seller at reduced or no cost to the buyer, per the terms of the redemption. (Steps 4 and 5.) The third party digital data processor 504, notified of the total cost of the buyer's purchase either by the participating seller digital data processor 502 (step 6) or from previously obtained information such as the product/service code, transfers money to the seller in an amount sufficient to compensate the seller 502 and in accord with any previously-existing reimbursement arrangements, as previously described. In step 8, the third party digital data processor 504 deducts the appropriate amount of money and/or points from the buyer's account.

Described above are methods and apparatus meeting the objects and goals set thereforth. Those skilled in the art will appreciate that the embodiments shown in the drawings and described in the accompanying text are merely examples and that other embodiments, incorporating modifications and changes therein and including combinations of foregoing embodiments, fall within the scope of the invention.

Thus, by way of non-limiting example, it will be appreciated that the steps depicted in the Figures may be performed in any suitable order, the ordinal numbering of those steps herein notwithstanding, as it provided only for explicative purposes. The use of known data processing techniques, known hardware configurations, and known programming constructs, including web-related programming, known data storage or database principles, are contemplated herein to effect the novel methods and apparatus disclosed herein.

1. A method of commerce effected at least in part via one or more digital data processors in communications coupling with one another, the method comprising:
A. communicating to at least one third party digital data processor, in connection with a purchase transaction between a buyer and a seller, any of a code for a product/service selected for purchase and a seller identification,
B. with the at least one third party digital data processor, communicating to any of at least one buyer digital data processor and the buyer a benefit inuring from the third party as a result of the purchase,
C. in view of the purchase transaction being consummated between at least one seller digital data processor and any of the buyer and the at least one buyer digital data processor, communicating a notification/receipt to the at least one third party digital data processor regarding the transfer of an amount of money based on the purchase transaction from the seller to a third party,
D. the at least one third party digital data processor crediting the buyer with an amount of money and/or points in an account with the at least one third party digital data processor that is associated with the buyer.

2. The method of claim 1, wherein at least steps (A) and (B) occur within a single visit to a virtual store defined by web pages served by the at least one seller digital data processor.

3. The method of claim 1, wherein at least steps (A), (B) occur in real-time.

4. The method of claim 1, further comprising the at least one third party digital data processor communicating to the at least one buyer digital data processor information for display to the buyer regarding a plurality of purchase options, each associated with a benefit inuring from the third party as a result of the selection of that purchase option.

5. The method of claim 4, wherein at least two of the purchase options involve different sellers.

6. The method of claim 5, wherein one of the sellers is the seller associated with the potential purchase transaction in step (A).

7. The method of claim 4, wherein at least two of the purchase options involve different products.

8. The method of claim 1, wherein the purchase transaction is consummated at a virtual store and wherein step (A) includes the at least one buyer digital data processor and/or the at least one third party digital data processor determining any of the product/service code and the seller identification therefrom.

9. The method of claim 8, wherein step (A) includes the at least one buyer digital data processor and/or the at least one third party digital data processor determining any of the product/service code and the seller identification from HTML defining the virtual store.

10. The method of claim 8, wherein step (A) includes the at least one buyer digital data processor and/or the at least one third party digital data processor determining any of the product/service code and the seller identification from an applications program interface associated with the virtual store.

11. The method of claim 8, wherein step (A) includes the at least one buyer digital data processor and/or the at least one third party digital data processor determining any of the product/service code and the seller identification from an HTTP address associated with the virtual store.

12. The method of claim 8, wherein the virtual store is defined by one or more web pages served by a server digital data processor associated with the seller.

13. The method of claim 8, wherein the virtual store is presented by a portal application executing on the buyer's digital data processor.

14. The method of claim 1, wherein the purchase transaction is consummated at a brick-and-mortar store.

15. The method of claim 14, wherein step (A) includes determining the product/service code from a bar code.

16. The method of claim 14, wherein step (A) includes determining the seller identification based on a location of the brick-and-mortar store.

17. The method of claim 14, wherein step (A) includes determining the seller identification based on buyer input.

18. The method of claim 17, wherein the buyer input is received via an input device associated with the at least one buyer digital data processor.

19. The method of claim 1, wherein the purchase transaction is consummated remotely from any of a virtual store and a brick-and-mortar store and wherein step (A) includes determining any of the product/service code and the seller identification from information supplied to the buyer in connection with the purchase transaction.

20. The method of claim 1, wherein step (B) includes the at least one third party digital data processor communicating to the at least one buyer digital data processor, for display to the buyer, an amount of money and/or points that will be credited in step (D).

21. The method of claim 1, where step for (C) the transferred amount of money is based on the amount of the purchase transaction.

22. The method of claim 21, where step for (C) the transferred amount of money is based on the nature of an affiliation between the seller and the third party.

23. The method of claim 1, where step (D) includes the at least one third party digital data processor crediting the buyer with an amount of money and/or points that is based on any of (i) the amount of the purchase transaction, and (ii) the amount of money that is transferred to the third party in step (B).

24. The method of claim 1, further comprising performing steps (A) and (B) multiple times for multiple respective potential purchase transactions with one or more sellers and/or one or more product/services.

25. The method of claim 24, where step (B) includes the third party digital data processor communicating to the at least one buyer digital data processor, for display to the buyer in a consolidated display, amounts of money and/or points that will be credited in step (D) for the multiple purchase transactions.

26. The method of claim 25, where for step (C), one or more of the purchase transactions are consummated from the consolidated display.

27. The method of claim 25, wherein the one or more sellers comprise at least two different sellers.

28. The method of claim 1, wherein the account associated with the buyer is a beneficiary account selected by the buyer.

29. The method of claim 28, wherein the beneficiary account is associated with a charitable organization.

30. The method of claim 1, further comprising:
E. communicating to the at least one third party digital data processor, in connection with a second potential purchase transaction between the buyer and any of the same seller as for steps (A)-(D) or another seller (collectively, “second seller”), any of a code for a product/service selected for purchase and a second seller identification,
F. with the at least one third party digital data processor, communicating to any of the buyer and the at least one buyer digital data processor any of a balance of money and/or points in an account with the third party and associated with the buyer and a cost to consummate the second potential purchase transaction by redeeming some or all of that money and/or points,
G. in view of a consummation of the second purchase transaction between the second seller and the buyer, communicating a notification/receipt to any of the buyer and the at least one buyer digital data processor regarding the debiting of money and/or points based on the second purchase transaction from the account associated with the buyer,
H. communicating a notification/receipt to at least one second seller digital data processor regarding the transfer, from the third party to the second seller, of an amount of money based on the second purchase transaction.

31. The method of claim 30, wherein for step (H), the amount of money transferred to the second seller reflects a deduction for a predetermined fee to the third party.

32. The method of claim 30, wherein step (F) includes the at least one third party digital data processor communicating to the at least one buyer digital data processor, for display to the buyer, a plurality of purchase options, each purchase option associated with a cost to consummate that purchase transaction using some or all of the money and/or points.

33. The method of claim 32, wherein at least two of the purchase options involve different sellers.

34. The method of claim 32, wherein at least two of the purchase options involve different products.

35. A method of commerce involving one or more digital data processors associated with a third party (collectively, “third party digital data processor”), one or more digital data processors associated with a buyer (collectively, “buyer digital data processor”), one or more digital data processors associated with a seller (collectively, “seller digital data processors”), the method comprising:
A. executing software on the third party digital data processor, the software configuring the third party digital data processor to receive, in connection with a purchase transaction any of a code for a product/service selected for purchase and a seller identification from any of the buyer digital data processor and the seller digital processor;
B. the third party digital data processor communicating to the buyer digital data processor a benefit inuring from the third party as a result of the purchase;
C. in association with the consummation of the purchase transaction between the buyer digital data processor and the seller digital data processor, the third party digital data processor receiving from the seller digital data processor a notification of a transfer of money from the seller to the third party based on the purchase transaction;
D. the third party digital data processor crediting the buyer with an amount of money and/or points in an account with the third party and associated with the buyer.

36-64. (canceled)

65. A method of commerce, comprising
A. consummating a purchase transaction between a seller and a buyer,
B. transferring from the seller to a third party money based on the purchase transaction,
C. crediting the buyer with an amount of money and/or points in an account with the third party.

66-72. (canceled)

73. A method of commerce effected at least in part via one or more digital data processors in communications coupling with one another, comprising
A. communicating to a shopping cart function, in connection with a potential purchase transaction between a buyer and a seller, any of a product/service being purchased and a seller identification,
B. performing step A for multiple respective purchase transactions with multiple respective sellers, thereby generating multiple potential purchase transactions, and
C. communicating to the buyer, in a consolidated display, the multiple potential purchase transactions,
D. responding to buyer input by consummating one or more of said potential purchase transactions.

74-84. (canceled)

85. A method of commerce, comprising:
A. communicating to a third party, in connection with a purchase transaction between a buyer and a seller, any of a code for a product/service selected for purchase and a seller identification,
B. communicating to the buyer a benefit inuring from the third party as a result of the purchase,
C. consummating the purchase transaction between a seller and a buyer,
D. transferring from the seller to a third party money based on the purchase transaction,
E. crediting the buyer with an amount of money and/or points in an account with the third party that is associated with the buyer.

86-118. (canceled)
